(19) United States
(12) Patent Application Publication
(10) Pub. No.: US 2011/0029333 A1
(43) Pub. Date: Feb. 3, 2011

(54) SYSTEM AND METHOD FOR CONTROLLING AND CALCULATING TIME OF SERVICE

(76) Inventors: Shlomo Zytman, Ra'anana (IL); Avraham Yehezkel Balsam, Zur Yigal (IL); Tsalel Zytman, Netanya (IL)

Correspondence Address: Pearl Cohen Zedek Latzer, LLP, 1500 Broadway, 12th Floor, New York, NY, 10036, US

(21) Appl. No.: 12/849,449

(22) Filed: Aug. 3, 2010

Related U.S. Application Data
(60) Provisional application No. 61/230,862, filed on Aug. 3, 2009.

(51) Int. Cl. G06Q 10/00

(52) U.S. Cl. 705/5; 705/7

(57) ABSTRACT

A system and method for organizing, controlling and managing a queue at a service center are disclosed. The system according to one embodiment comprises a main processing unit to calculate parameters regarding time of service, at least one peripheral processing unit, a customer queue number feed device to provide customers in a service center with an indication of their position in line for a certain service, a service number display means, a line progress display means, and at least one service point, provided with a service point terminal to provide to the peripheral processing unit information regarding the progress of service. The peripheral processing unit may be in active communication with the main processing unit, with at least one service point terminal at each service point, and with the customer queue number feed device, to collect information regarding time of service.

### CROSS REFERENCE TO RELATED APPLICATIONS

This application claims the benefit of U.S. Provisional Patent Application No. 61/230,862, filed on Aug. 3, 2009, the entire contents of which are incorporated in their entirety by reference herein.

### FIELD OF THE INVENTION

The present invention relates to a system and method to organize, control, mange and calculate the time of service in service centers.

### BACKGROUND OF THE INVENTION

Known systems and methods for organizing a line, or a queue, to a service point or center, do not provide a sufficient solution that minimizes the time wasted by customers waiting in line, and do not provide tools for managing and controlling the time to service.

### SUMMARY OF EMBODIMENTS OF THE INVENTION

It is an object of the present invention to provide a system and a method for controlling, managing and organizing queues to one or more service points in one or more service centers.

In particular, the invention provides, according to some embodiments, a system and method to collect information regarding parameters that influence the time of service, process the collected information and produce an estimation of the time until service will be given to each customer in line. A further object of the present invention is to allow customers to reserve a place in a line for a service while eliminating the need to visit the service center prior to the time in which each customer is expected to receive service.

Another object of the present invention is to provide the manager of a service center a system and a method to allow better management of personnel and better control on the time of service.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram illustrating a system for organizing and controlling a queue in a plurality of service centers according to one embodiment of the present invention;

FIG. 2 is a flowchart illustrating a method according to an embodiment of the present invention;

FIG. 3 is a flowchart illustrating a method according to another embodiment of the present invention; and

FIG. 4 is a flowchart illustrating a method according to another embodiment of the present invention for managing a service center.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. The detailed description below refers to a queue of customers waiting for service at a service center; however, it would be appreciated by those skilled in the art that the system and methods described hereinafter may be applied to a queue of products or processes and are not limited to the examples detailed below.

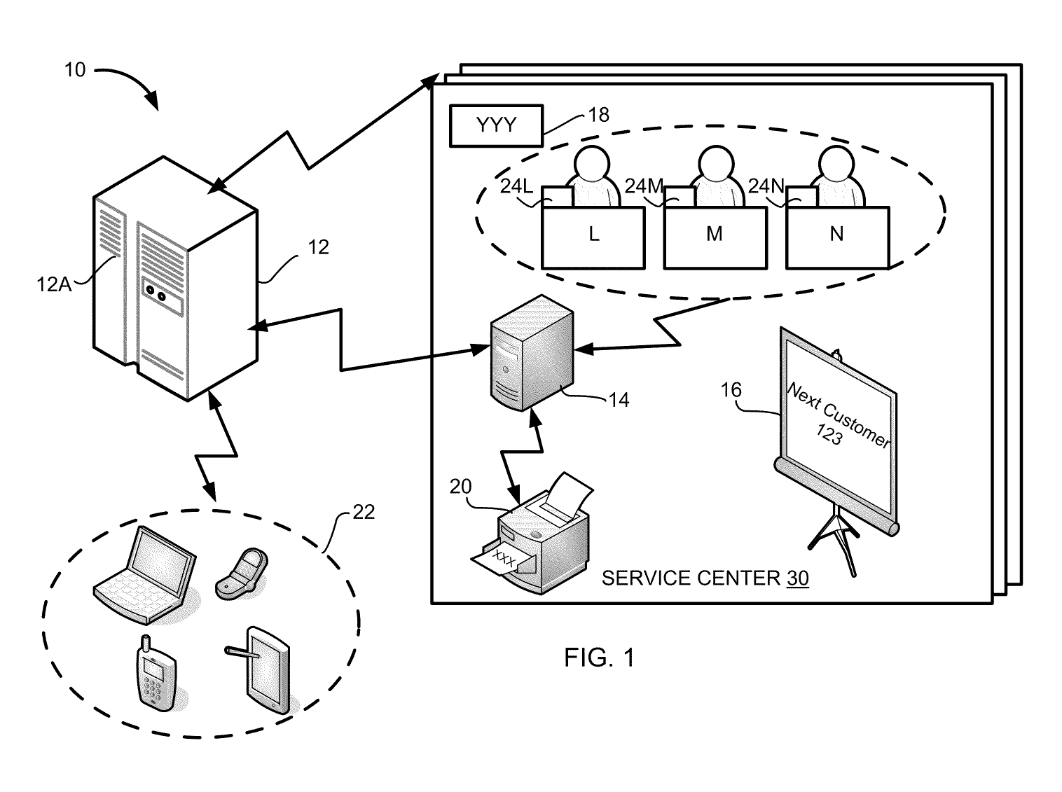

Reference is now made to FIG. 1 which is an illustration of a system 10 for organizing and controlling a queue according to one embodiment of the present invention. System 10 may further allow pre-calculation and estimation of the expected time until a service which was called for by a customer will be provided to each and every customer in line, and may be adapted to provide, both to the customers and to the service provider, information regarding the progress of service, delays in service, information regarding the efficiency of the service and the like.

System 10 may comprise a main processing unit 12 which may be in active communication with a plurality of service centers 30 of one or more service providers such as banks, cellular service providers, hospitals, post offices and the like. Main processing unit 12 may be actively connected to at least one peripheral processing unit 14 at each service center 30. However, in some embodiments of the present invention, main processing unit 12 and peripheral processing unit 14 may be substitutes (i.e. may serve the same functions and replace one another in case of failure of one of the two processing units, or when only one of the two processing units exist in the system) and/or integrated in a single unit.

Main processing unit 12 may be adapted to receive data provided from a customer through a non-dedicated communication device such as cellular phone 22. Main processing unit 12 may further be adapted to send information to a non-dedicated communication device such as cellular phone 22.

System 10 may further comprise a customer queue number feed device 20 at each service center 30, to provide customers in a service center 30 with numbers or other type of indicator, such as queue number XXX, or any other indication, indicative of each customer's position in line for a certain service. Customer queue number, once allocated to a customer, may be associated with a specific time slot in a waiting line for a specific service, yet the time slot associated with a specific customer number may be changed by system 10, as will be described hereinafter. Customer queue number feed device 20 may be a simple paper roll comprised from a plurality of tags with a unique number, such as number XXX, printed on each tag. In yet another embodiment of the present invention customer queue number feed device 20 may be a printer, adapted to print upon demand a number which differs from the previous numbers (such as a number that follows previous numbers) printed but is not necessarily consecutive. For instance, according to some embodiments of the present invention the printed numbers or the tags may provide only odd or only even numbers, allowing the system to reserve positions in the line for customers who reserved a time slot in advance as will be further described hereinafter. According to yet another embodiment of the present invention, customer queue number feed device 20 may be, or may comprise, a communication device to allow said feed device 20 to send an indication of the customer's location in waiting line directly to customer's non-dedicated communication device. It would be appreciated by those skilled in the art that said communication device of feed device 20 may be in active communication with peripheral processing unit 14 or with main processing unit 12, to allow feed device 20 to receive information regarding service requests received from customers and to receive information regarding available time slots and thus available queue numbers. According to one embodiment of the present invention, customer queue number feed device 20 may be associated with peripheral processing unit 14 to provide peripheral processing unit 14 with information such as the number of service requests/customers waiting for service in service center 30 and the rate of addition of service requests/customers. It would be appreciated that this information may be indicative of the expected load in service center 30 and may be used in order to calculate the expected waiting time.

It will be appreciated however, that according to some embodiments of the present invention, customer queue number feed device 20 may be integrated in peripheral processing unit 14 or in main processing unit 12 and a customer may receive an indication of his or hers location in line through alternative means, such as directly to non-dedicated communication device 22.

System 10 may further comprise a service number display 18. Service number display 18 may be a changeable display system such as an LCD monitor. In yet another embodiment according to the present invention, the service number YYY may be presented on a permanent display such as a sign. In yet another embodiment of the present invention, the service number YYY may be indicated on the customer number tag or printout, thus eliminating the need for service number display 18.

Peripheral processing unit 14 may further be in active communication with line progress display means 16 and service number display means 18. According to one embodiment of the present invention, line progress display means 16 may be an alphanumeric screen, an LCD monitor or any other display means known in the art. Line progress display means 16 may be adapted to display an indication, such as a number or a plurality of numbers, indicative of the progress of the line e.g. a queue number of the customer receiving service at a given moment, an indication of the next customer to be served, information regarding an available service point such as service points L, M and N or the like. According to some embodiments of the present invention, the information displayed on line progress display means 16 may also be provided to peripheral processing unit 14.

Each service point L, M and N may be provided with a service point terminal 24 adapted to allow each service person to enter data regarding the progress of service to peripheral processing unit 14. Each terminal 24L, 24M, 24N etc. may be associated with a specific service point. Terminal 24 may be a keyboard, a button or any other input means known in the art. Terminals 24L, 24M, 24N, . . . , may be actively connected to peripheral processing unit 14, to allow collection of data regarding the progress of the service at each service point.

In some instances, a customer may have to be sent, by a service person to another service point or center. For example, a customer may request service from a medical center, after the customer is examined by a doctor, the doctor may request further examination in a different medical center or unit such as an expert doctor or an x-ray center. Terminals 24 may therefore allow, according to some embodiments of the present invention, a service person to forward a service request with the customer's data to another service point or center when further or different service is required.

According to an embodiment of the present invention, main processing unit 12 receives data from peripheral processing unit 14 and from customers via non-dedicated communication device 22. The data received from peripheral processing unit 14 may include, for example, the number of customers waiting in line, the number of active service points, the number of service points expected to be active in a the relevant time frame, the identity of each cashier, or service person, in each service point and the number of the next customer to be served. In some embodiments of the present invention the data from peripheral processing unit 14 is sent to main processing unit 12 in a continuous manner. In alternative embodiments the data may be sent to main processing unit 12 every predetermined period of time. In yet another embodiment of the present invention, the data is sent to main processing unit 12 upon each change in the data. For example, each time a customer takes a number (i.e. registers to receive a certain service) from number feed device 20 an update may be sent to main processing unit 12. According to some embodiments of the present invention, the information regarding to progress of the line may be obtained by peripheral processing unit 14 which may be connected to all or some of terminals 24, displays 16 and 18, customer queue number feed device 20 and/or main processing unit 12. According to other or additional embodiments of the present invention the information regarding the progress of the line may be obtained optically, for example by a video camera or several video cameras (not shown). The optical means such as video cameras may have display 16 within their field of view so that display 16 is readable by peripheral processing unit 14 or by main processing unit 12. The optical means such as video cameras may be in active connection to peripheral processing unit 14 or may be actively connected directly to main processing unit 12. It would be appreciated by those skilled in the art that this embodiment allows the application of the system according to some embodiments of the invention, without replacing existing queue management systems already operating in some service centers 30.

Main processing unit 12 may further comprise a storage device 12A to store pre-obtained data regarding typical service time in different conditions. According to some embodiments of the present invention, information regarding the efficiency of each service person is stored in storage device 12A and may be used to fine tune the estimation of expected time until a customer will receive service.

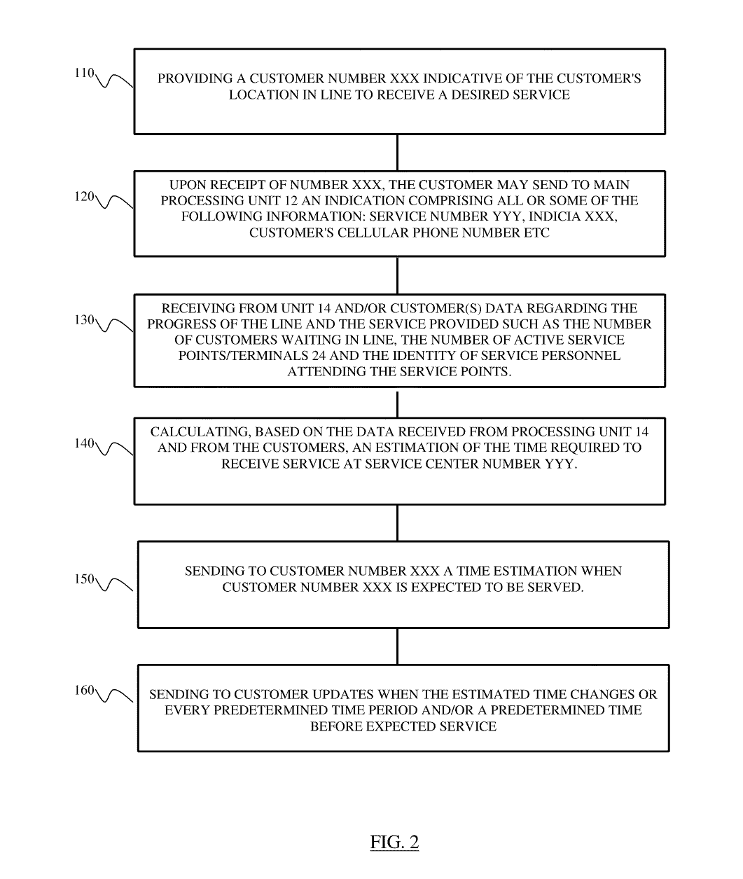

Reference is now made to FIG. 2 which is a flowchart illustrating a method according to one embodiment of the present invention. The method comprises the following steps:

Providing a customer queue number XXX indicative of the customer's location in line to receive a desired service (block 110). The customer queue number XXX may be provided by customer queue number feed device 20 or may be sent to a customer upon request directly to the customer's communication device 22.

Upon receipt of queue number XXX, the customer may send to main processing unit 12 an indication comprising all or some of the following information: service number YYY, queue number XXX, customer's cellular phone number etc. (block 120). It should be noted however, that when the non-dedicated communication device used by the customer is a cellular phone, the phone number may be extracted by main processing unit 12 using caller ID systems known in the art. The information may be sent to main processing unit 12 via a Short Message Service (SMS) or by any other means known in the art.

Main processing unit 12 receives from peripheral processing unit 14 data regarding the progress of the line and the service provided (block 130), such as the number of customers waiting in line (which is the number of number tags or prints taken from customer queue number feed device 20 and the number of time slots reserved by customers via a non-dedicated communication device 22 minus the number of customers that has already received service or left the line prior to receiving service), the number of customers that are late or that missed their reserved time slot, number of customers redirected from another service center or another service point, technical problems in service points that may delay service, the types of services required, the number of active service points/terminals 24 and the identity of service personnel attending the service points. It would be appreciated that the length of the line may alternatively or additionally be calculated based on the number of customers sending an indication to main processing unit 12 via non-dedicated communication device 22.

The data received from peripheral processing unit 14 is processed by main processing unit 12, which calculates, based on the data received from processing unit 14 and from the customers, an estimation of the time required to receive service at service center 30 (block 140).

Main processing unit 12, extract from the data provided by peripheral processing unit 14, information regarding the average time required to attend a customer, and based on this information, the number of customers waiting in line, and the location of customer number XXX in line, a time estimation until customer number XXX will be served, may be calculated. It should be noted that the number of customers waiting in line may be further calculated based on the information received from the customers via non-dedicated communication device 22. According to some embodiments of the present invention the calculation may be further based on the frequency of new service requests received from customers via each customer's non dedicated communication device 22 and via queue number feed device 20, number of customers that were redirected from another service center or service point, and the number of customers that left the line prior to receiving service.

In another embodiment of the present invention, main processing unit 12 may use pre-obtained and stored information regarding the typical average time of service in different times of the day and/or the year, information regarding the typical efficiency (i.e. the typical average service time) of each individual service person, the typical number of customers leaving the line prior to receiving service in a given time period and under given service conditions such as when the waiting time exceeds a certain time limit, the number of customers waiting for service, and the like, in order to fine-tune the time estimation until a customer will receive service. In yet another embodiment of the present invention, main processing unit 12 may update the pre-obtained data based on data received from peripheral processing unit 14.

Main processing unit 12 may then send to customer number XXX time estimation when should customer number XXX be served (block 150). The time estimation and updates may be sent by SMS to the customer's non-dedicated communication device 22 or by any other means known in the art. According to some embodiments an update may be sent to the customer whenever the time estimation changes and/or every predetermined time period, such as every 15 min and/or 15 minutes before expected service (block 160).

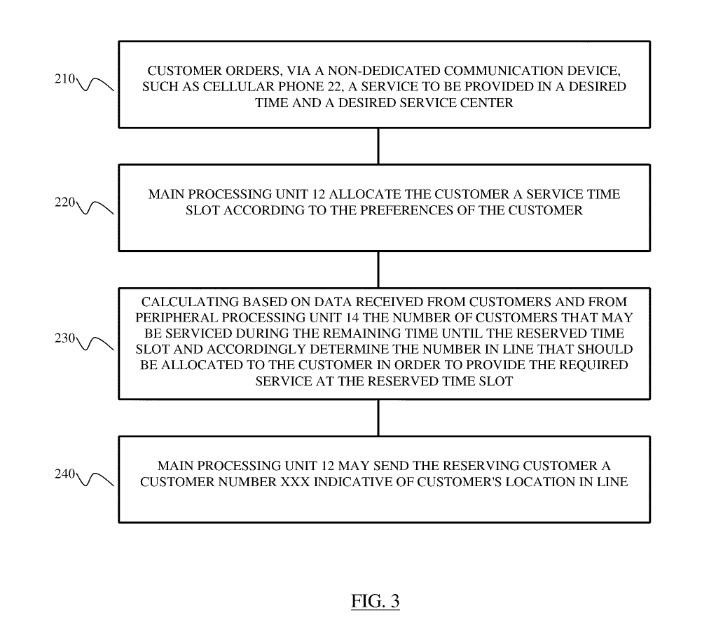

Reference is now made to FIG. 3 which is a flowchart illustrating a method 200 according to another embodiment of the present invention. Method 200 illustrated in FIG. 3 allows a customer to reserve a place in line without attending service center 30. Method 200 may comprise the following steps:

Customer orders, via a non-dedicated communication device, such as cellular phone 22, a service in a desired time and a desired service center 30 (block 210).

Main processing unit 12 may allocate the customer a service time slot according to the preferences of the customer (block 220). It would be appreciated that the term “time slot” is not limited to a specific hour and a customer may reserve, for instance, the earliest time slot available, the latest time slot available, the earliest available time slot after a certain hour of the day or any other specific or non-specific time slot.

Main processing unit 12 may then calculate based on data received from customers and from peripheral processing unit 14 the number of customers that may be serviced during the remaining time until the reserved time slot and accordingly determine the number in line that should be allocated to the reserving customer in order to provide the customer the required service at the reserved time slot (block 230).

Main processing unit 12 may send the reserving customer a customer queue number XXX indicative of customer's location in line (block 240). According to some embodiments of the present invention, main processing unit 12 may send updated customer queue number XXX' in order to allow the customer to receive the desired service at the desired time, or may send an update regarding the expected time the service will be provided to the reserving customer. It would be appreciated by those skilled in the art that the customer may receive the desired service by presenting the queue number sent to him or her via non-dedicated communication device 22 at the service center 30 instead of printing or taking a queue number tag. Alternatively, according to an embodiment of the present invention the customer may print his queue number at the service center 30, after been identified by system 10 by any identification means known in the art.

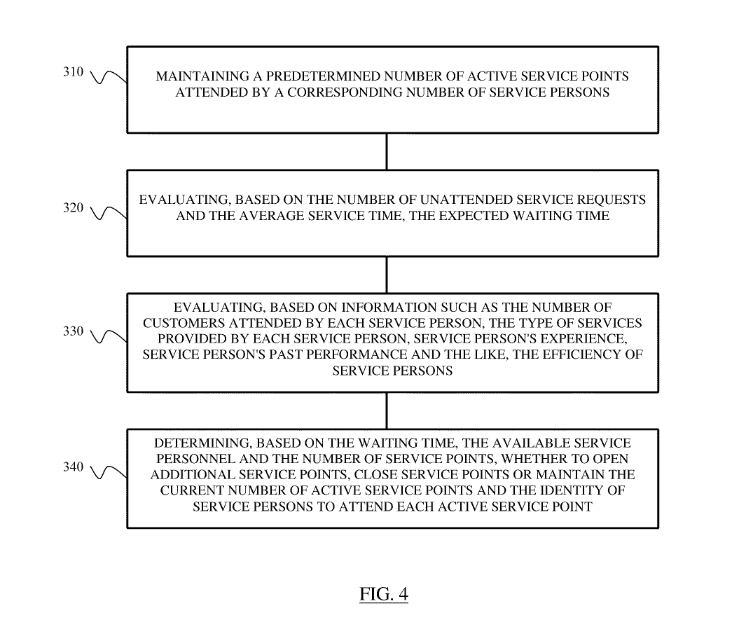

Reference is now made to FIG. 4 which is a flowchart of a service center managing method according to an embodiment of the present invention. The method illustrated in FIG. 4 may comprise the following steps:

Maintaining a predetermined number of active service points attended by a corresponding number of service persons (block 310).

Evaluating, based on the number of unattended service requests and the average service time, the expected waiting time (block 320).

Evaluating, based on information such as the number of customers attended by each service person, the type of services provided by each service person, service person's experience, service person's past performance and the like, the efficiency of service persons (block 330).

Determine, based on the waiting time, the available service personnel and the number of service points, whether to open additional service points, close service points or maintain the current number of active service points and the identity of service persons to attend each active service point (block 340).

According to another embodiment of the present invention, only waiting time may be taken into consideration in determining how many service points should be activated. While certain features of the invention have been illustrated and described herein, many modifications, substitutions, changes, and equivalents will now occur to those of ordinary skill in the art. It would be appreciated by those skilled in the art that the system and methods described above may be applied to a queue of products or processes and are not limited to a queue of customers. It is, therefore, to be understood that the appended claims are intended to cover all such modifications and changes as fall within the true spirit of the invention.

We claim:

1. a system for organizing and controlling a queue, the system comprising:
a main processing unit to calculate parameters regarding time of service;
at least one peripheral processing unit;
a customer queue number feed device to provide customers in a service center with an indication of their position in line for a certain service;
a service number display means;
a line progress display means; and
at least one service point, each of said at least one service points is provided with a service point terminal to provide to said at least one peripheral processing unit information regarding the progress of service;
wherein said at least one peripheral processing unit is in active communication with said main processing unit, with said at least one service point terminal at each of said at least one service points, and with said customer queue number feed device, to collect information regarding time of service.

2. The system of claim 1 wherein said main processing unit and said at least one peripheral processing unit are substitutes.

3. The system of claim 1 wherein said main processing unit and said at least one peripheral processing unit are integrated in a single unit.

4. The system of claim 1 wherein said main processing unit and said peripheral processing unit are adapted to receive data provided from at least one customer through a non-dedicated communication device.

5. The system of claim 4 wherein said non-dedicated communication device is a cellular phone.

6. The system according to claim 4 wherein said main processing unit calculates, based on information received from peripheral processing unit and from customers non dedicated communication device, the expected time until a service will be provided to each customer in line, the progress of service, delays in service, and efficiency of the service.

7. The system according to claim 1 wherein said customer queue number feed device is at least one from a list comprising: a printer adapted to print upon demand an indication of a customer's location in line, a paper roll and a communication device adapted to send an indication of a customer's location in line to customer's non-dedicated communication device.

8. The system according to claim 1 wherein said customer queue number feed device and said at least one peripheral processing unit are integrated in a single unit.

9. The system according to claim 1 wherein said main processing unit is adapted to send an indication to customer's non-dedicated mobile communication device;
wherein said indication includes one or more of a list comprising: the number of the customer in line, the time the customer is expected to receive service, the remaining time until customer will receive service, the service point number, and the type of service.

10. The system according to claim 1 wherein said main processing unit further comprises a storage device to store pre-obtained data regarding typical service time in different conditions; wherein said pre-obtained data is one or more from a list comprising: the efficiency of each service person, the average service time per service person, the average service time in each hour during the day, the average service time during different times of the year, the average number of customers leaving the line before receiving service, and the average number of customers returning to line or redirected to a service point; wherein said pre-obtained data is used to fine tune the calculated parameters, calculated by said main processing unit.

11. The system of claim 1 further comprising at least one optical means to collect information regarding the progress of the line and provide said information to said peripheral processing unit,

12. The system according to claim 11 wherein said at least one optical means is a video camera.

13. A method for organizing and controlling a queue, comprising:
providing a customer with a first indication, indicative of the customer's location in line to receive a desired service;
sending to main processing unit a second indication, said indication including customer's identification information;
sending information regarding the progress of the line and the service provided, from peripheral processing unit to main processing unit;
processing information received from peripheral processing unit and from customers;
calculating, based on said processed information, an estimation of the time required to receive service at a service center;
sending to customer's non-dedicated communication device, a time estimation when should the customer be served.

14. The method according to claim 13 wherein said first indication is a queue number provided to customer by customer queue number feed device.

15. The method according to claim 13 wherein said first indication is a queue number provided to customer directly to said customer's non dedicated communication device.

16. The method according to claim 13 wherein said processed information includes one or more of a list comprising: average time required to attend a customer, number of customers waiting in line, number of active service points, identity of service personnel attending said service points, frequency of new service requests received from customers via customer's non dedicated communication device and via queue number feed device, number of customers that left the line prior to receiving service, and the location of each customer in line.

17. The method according to claim 16 wherein said calculation is further based on pre-obtained information, wherein said pre-obtained information comprises one or more of a list comprising: typical average time of service in different times of the day, average time of service in different times of the year, average service time of each individual service person attending each service points and the typical number of customers leaving the line prior to receiving service in a given time period and under given service conditions.

18. The method according to claim 17 wherein said pre-obtained data is updated based on data received from said peripheral processing unit.

19. The method according to claim 13 further comprising:
sending updated time estimations to customer when there is a change in estimated time to service from previously sent estimation.

20. The method according to claim 19 wherein said time estimation and said updates are sent to the customer's non-dedicated communication device.

21. The method according to claim 13 wherein said second indication includes one or more details from a list comprising: service number, queue number and customer's cellular phone number.

22. The method according to claim 16 wherein the number of customers waiting in line is the number of number tags or prints taken from customer queue number feed device and the number of time slots reserved by customers via a non-dedicated communication device, minus the number of customers that has already received service or left the line prior to receiving service.

23. The method according to claim 13 further comprising the steps of receiving a service reservation request from customer, via a non dedicated communication device, allocating the customer a service time slot and calculating the number of customers that may be serviced during the remaining time until the reserved time slot, prior to providing a customer with a first indication, indicative of the customer's location in line to receive a desired service;

24. The method according to claim 23 further comprising the step of sending an updated queue number to customer to allow the customer to receive the desired service at the reserved time slot.

25. A method for managing a service center comprising:
maintaining a predetermined number of active service points attended by a corresponding number of service persons;
evaluating, based on the number of unattended service requests and the average service time, the expected waiting time;
evaluating the efficiency of each service person, based on information comprising the number of customers attended by each service person, the type of services provided by each service person, service person's experience and service person's past performance; and
determine, based on the waiting time, the available service personnel and the number of service points, whether to open additional service points, close service points or maintain the current number of active service points and the identity of service personnel to attend each active service point.
